(19) United States
(12) Patent Application Publication
(10) Pub. No.: US 2025/0392446 A1
(43) Pub. Date: Dec. 25, 2025

(54) DATA ENCODING METHOD

(71) Applicant: WAGO Verwaltungsgesellschaft mbH, Minden (DE)

(72) Inventor: Markus WEIDNER, Minden (DE)

(73) Assignee: WAGO Verwaltungsgesellschaft mbH, Minden (DE)

(21) Appl. No.: 19/249,105

(22) Filed: Jun. 25, 2025

(30) Foreign Application Priority Data
Jun. 25, 2024 (DE) 102024117836.1

(51) Int. Cl. H04L 9/08

(52) U.S. Cl. CPC H04L 9/0819

(57) ABSTRACT

Provided is an encoder, a decoder, and a method for encoding first data, in which the channel coding of the first data is parameterized by a secret key.

This nonprovisional application claims priority under 35 U.S.C. § 119 (a) to German Patent Application No. 10 2024 117 836.1, which was filed in Germany on Jun. 25, 2024, and which is herein incorporated by reference.

### FIELD OF THE INVENTION

The present invention relates to a method for encoding data. In particular, the present invention relates to a method for channel coding data.

### DESCRIPTION OF THE BACKGROUND ART

Channel encoding attempts to make errors, which may occur during data transmission over a disturbed (noisy) channel, detectable and, potentially, correctable at the receiver-side by adding redundancy at the transmitter-side.

### SUMMARY OF THE INVENTION

It is therefore an object of the invention to provide a method for encoding first data may comprise channel coding the first data, wherein the channel coding is parameterized by a secret key.

The term “encoding”, may be understood, in particular, as deriving encoded data from data to be encoded on the basis of an assignment rule which enables receiver-side decoding. If encoding is lossless and no (uncorrectable) errors occur, the data to be encoded can be recovered from the encoded data at the receiver. In this context, the term “channel coding”, may be understood, in particular, as referring to an assignment rule which adds redundancy as per the assignment so that data errors which may occur, for example, during transmission over a disturbed channel can be detected and, potentially, corrected. Furthermore, the term “secret key”, may be understood, in particular, as referring to an information base of an assignment rule by which it is attempted to prevent, or reduce the risk of, unauthorized access to the data through not making the information base publicly accessible or known, so that inverting the assignment is not easily possible. Moreover, the term “parameterization” may be understood, in particular, as referring to the exercise of a choice through which the assignment rule is specified, e.g. by selecting a specific assignment rule from a large number of possible assignment rules.

Second data may be derived from the first data by the channel coding and the method may further comprise encrypting the second data using the secret key.

The term “encrypting”, may be understood, in particular, as referring to assigning data to encrypted data using a secret assignment rule which is identified by the secret key.

According to an example, a method for encoding first data may comprise deriving second data from the first data, wherein the first data can be reconstructed from a part of the second data, and encrypting the second data with a secret key, wherein the deriving of the second data from the first data is based on the secret key.

The wording that “the first data can be reconstructed from a part of the second data”, may be understood, in particular, to mean that the second data is at least partially redundant.

Adding redundancy in deriving the second data from the first data may be based on the secret key.

For example, the second data may be derived from the first data within the framework of a channel coding routine, wherein the channel coding routine may be parameterized by the secret key. The parameterization may affect the code rate, such that different secret keys may lead to different code rates, or it may be code rate neutral, such that different secret keys lead to the same code rate.

Deriving the second data from the first data may be based on a block encoder which divides the first data into blocks, wherein the lengths of the blocks and/or an amount of redundancy added to a respective block and/or a system of adding redundancy to the blocks are based on the secret key.

The term “block encoder”, may be understood, in particular, as referring to an encoder which encodes successive blocks independently of one another.

Deriving the second data from the first data may be based on a stream encoder, the parameterization of which may change after a certain amount of stream-encoded data, wherein the change in parameterization may be based on the secret key.

The method may further comprise puncturing the data encoded by the stream encoder, wherein the puncturing is based on the secret key.

For example, the secret key may have an effect on the code rate and puncturing may ensure that the punctured data has a uniform code rate. If, for example, a certain secret key leads to an increase in redundancy, the puncturing may be adjusted accordingly to ensure that the code rate of the punctured data remains constant.

The method may further comprise grouping the second data or the encrypted second data into symbols and permuting the symbols, wherein the permuting may be based on the secret key.

One or more alphabets, by symbols of which the first data, the second data, and/or the encrypted second data may be represented, may be based on the secret key.

In this regard, the wording that “one or more alphabets . . . are based on the secret key”, may be understood, in particular, to mean that the one or more alphabets are parameterized by the secret key.

Deriving the second data from the first data and encrypting the second data on the basis of the secret key may be carried out under the condition that the encrypted second data completely or at least partially fills a payload area of a message of predetermined size.

According to a third aspect, an encoder may be configured to carry out the methods.

According to a fourth aspect, a decoder may be configured for error detection and/or error correction when decoding channel-coded data, wherein the decoding is based on a secret key with which the data is encrypted.

Furthermore, the features described in connection with the methods may also be features of the encoder/decoder and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a method for encoding data;

FIG. 2 shows additional steps to the method illustrated in FIG. 1;

FIG. 3 illustrates an example of the method shown in FIG. 2;

FIG. 4 illustrates an example of the method shown in FIG. 2;

FIG. 5 illustrates a first modification of the example shown in FIG. 3 and FIG. 4;

FIG. 6 illustrates a second modification of the example shown in FIG. 3 and FIG. 4;

FIG. 7 illustrates a third modification of the example shown in FIG. 3 and FIG. 4;

FIG. 8 illustrates a transmission of data via a transmission channel;

FIG. 9 shows a flowchart of a first method; and

FIG. 10 shows a flowchart of a second method.

### DETAILED DESCRIPTION

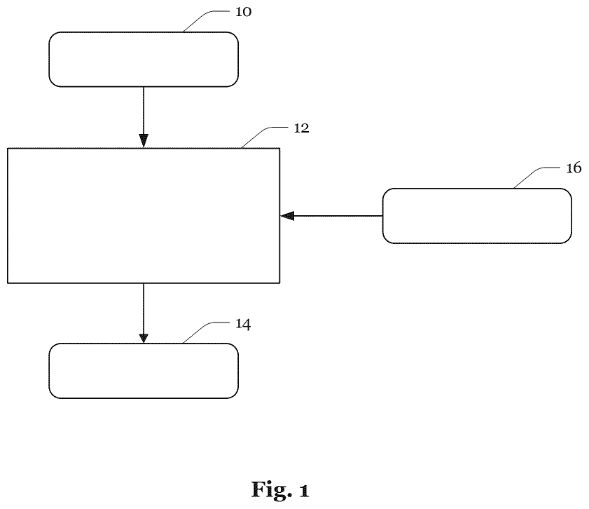

FIG. 1 shows a schematic diagram illustrating the encoding of digital data 10. Therein, digital data 10 is fed to a channel encoder 12 which derives channel-coded data 14 from the digital data. The mode of operation of the channel encoder 12 depends on a secret key 16 by which the channel encoder 12 is parameterized. If the parameterization of the channel encoder 12 is known, the digital data 10 can be recovered from the channel-coded data 14.

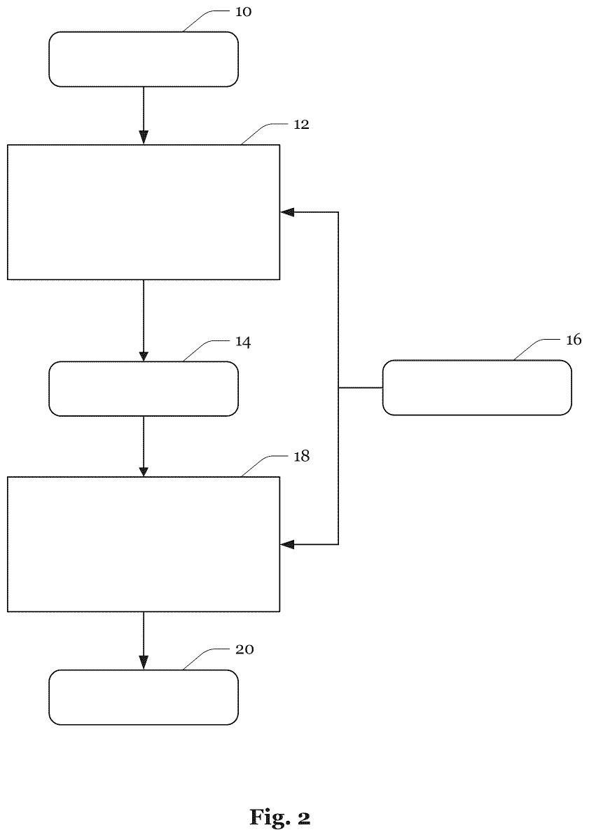

FIG. 2 shows a schematic diagram illustrating the encoding of digital data 10, in which the channel-coded data 14 of the schematic diagram in FIG. 1 is fed to a cryptographic encoder 18 which derives encrypted data 20 from the channel-coded data 14. The derivation of the encrypted data 20 from the channel-coded data 14 is based on the secret key 16. The secret key 16 may therefore not only be used to encrypt the data 14. Rather, the derivation of the channel-coded data 14 from the digital data 10 may also be based on the secret key 16.

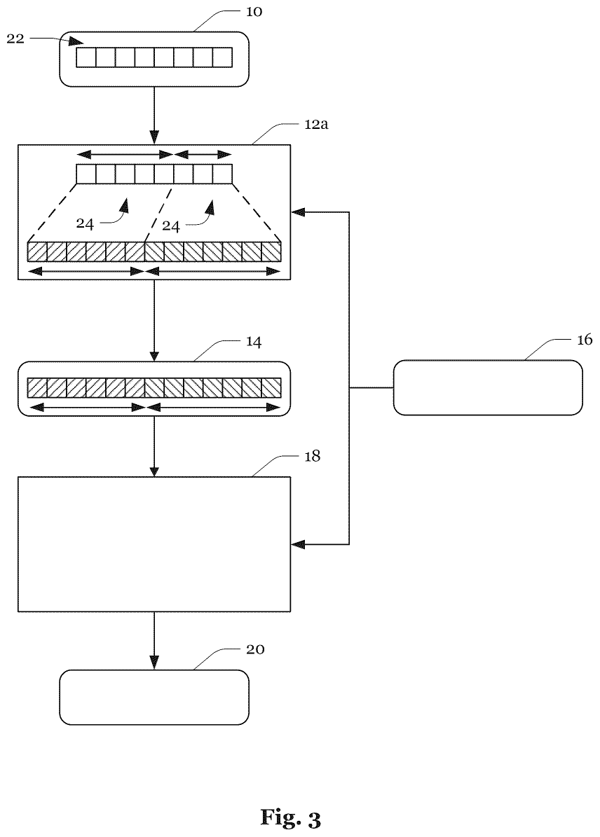

FIG. 3 shows a schematic diagram illustrating the encoding of digital data 10, in which the channel encoder 12 is a block encoder 12a. The block encoder 12a groups the symbols 22 into blocks 24 and channel codes the blocks 24 independently of one another. The length of the individual blocks 24 and the amount of redundancy added to a respective block 24 is based on the secret key 16. Likewise, the process by which redundancy is added, i.e. the relationship between the symbols 22 in a block 24 before and after channel coding, may be based on the secret key 16.

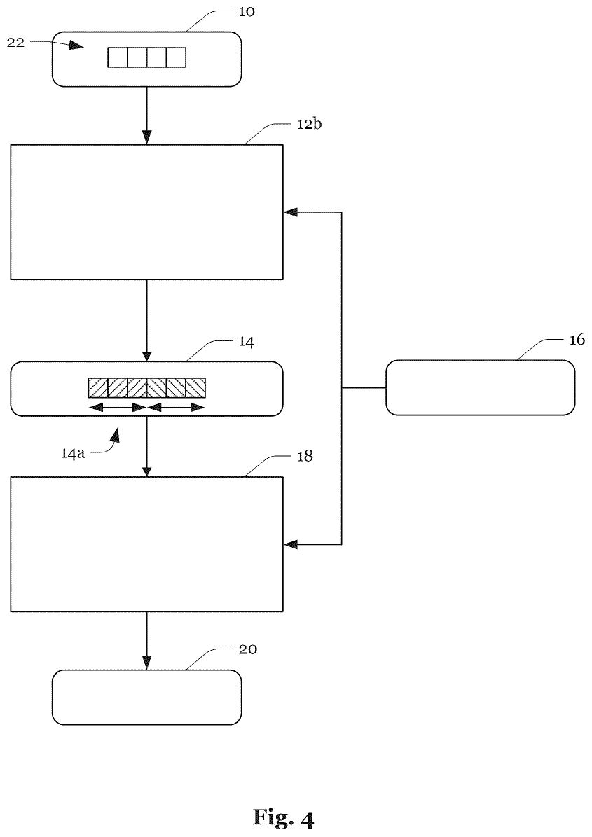

FIG. 4 shows a schematic diagram illustrating the encoding of digital data 10, in which the channel encoder 12 is a stream encoder 12b. The parameterization of the stream encoder 12b on the basis of the secret key 16 causes the way redundancy is added to change after a certain amount 14a of channel-coded data 14, wherein the certain amount 14a may be given by the secret key 16. Because the specific amount 14a cannot be easily determined without knowledge of the secret key 16, an additional barrier against unauthorized access to the digital data 10 may be created.

Alternatively, the parameterization of the stream encoder 12b on the basis of the secret key 16 may cause the way redundancy is added to change after a certain number of symbols 22 processed by the stream encoder 12b, wherein the certain number may be given by the secret key 16. Because the specific number cannot be easily determined without knowledge of the secret key 16, an additional barrier against unauthorized access to the digital data 10 may be created.

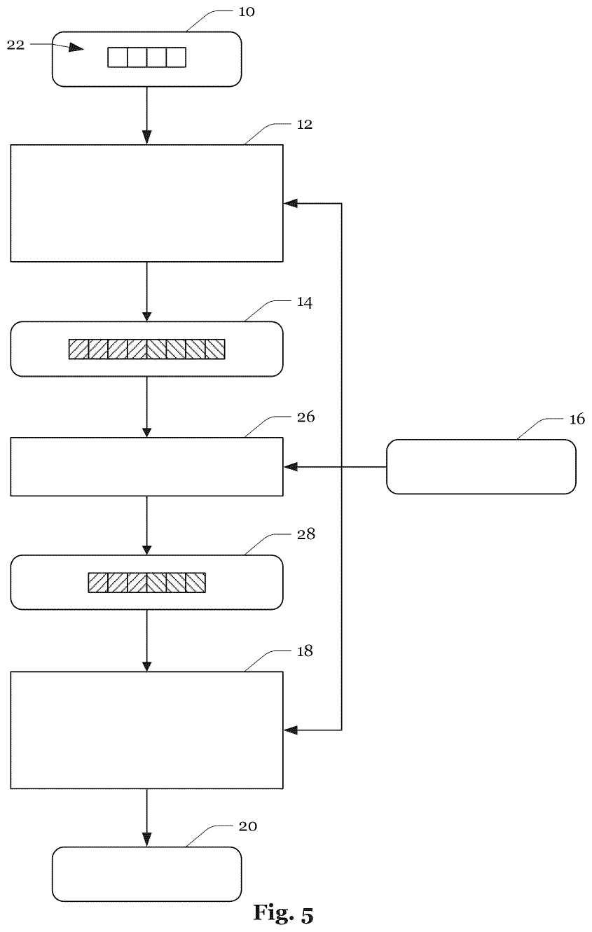

FIG. 5 illustrates a modification of the example shown in FIG. 3 and FIG. 4, in which a puncturer 26 is arranged downstream of the channel encoder 12, which ensures that a fluctuation of the code rate due to the dependence of the channel coding on the secret key 16 is reduced or completely avoided. This may ensure that the code rate of the punctured data 28 is independent of the secret key 16 used.

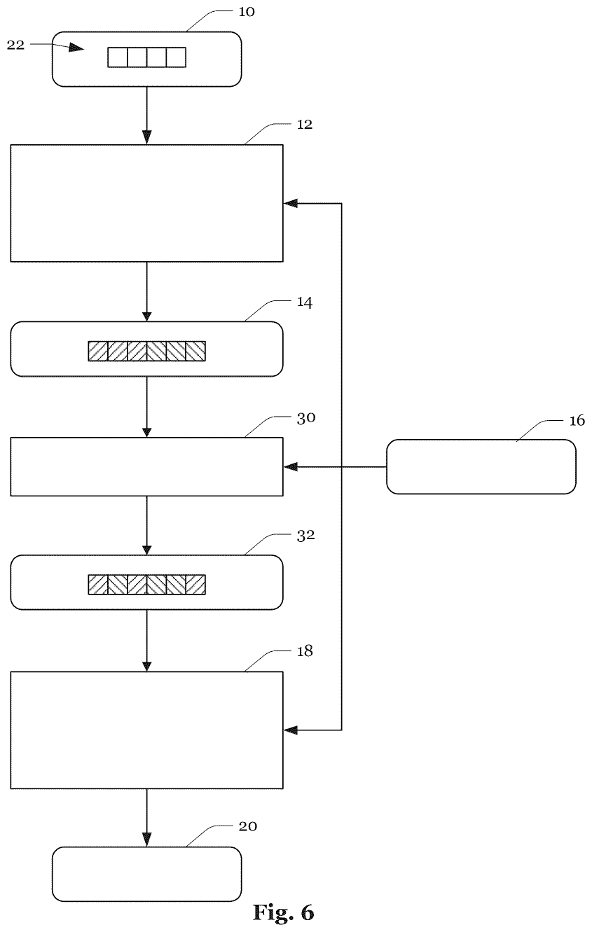

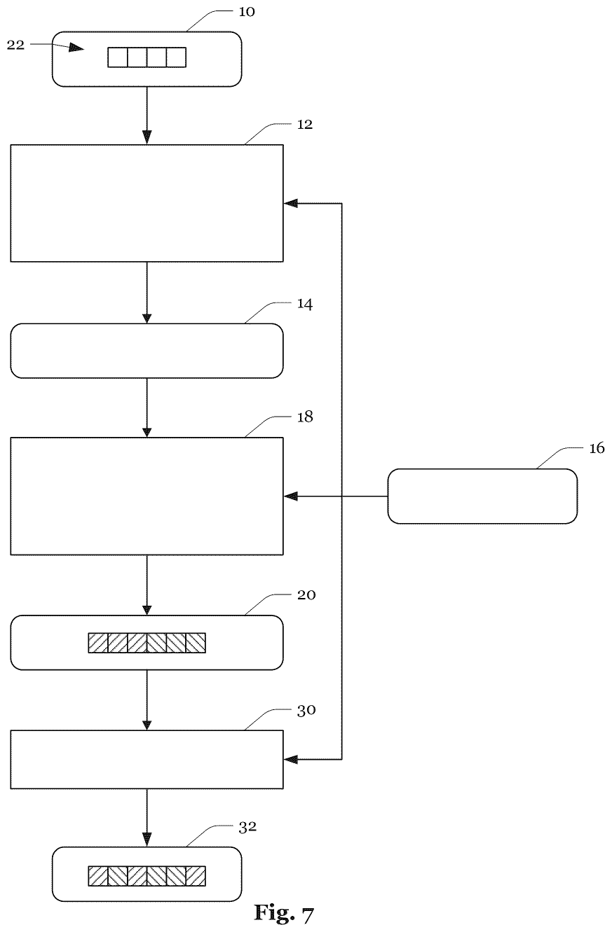

FIG. 6 illustrates a modification of the exemplary example shown in FIG. 3 and FIG. 4, in which a permutator 30 is arranged downstream of the channel encoder 12, which ensures that the symbols of the channel-coded data 14 are permuted. The permuted data 32 are then fed to the cryptographic encoder 18. FIG. 7 illustrates a modification of the example shown in FIG. 3 and FIG. 4, in which the permutator 30 is arranged downstream of the cryptographic encoder 18. It is noted that the modifications illustrated in FIG. 6 and FIG. 7 may also be combined with the modification illustrated in FIG. 5 by arranging puncturer 26 upstream or downstream of the permutator 30.

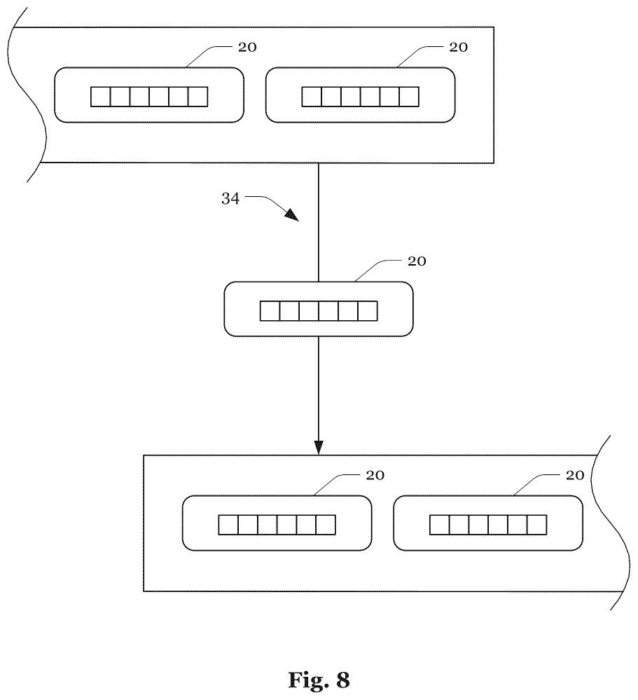

FIG. 8 illustrates a transmission of the encrypted data 20 (or the permuted data 32 in the case of the modification according to FIG. 7) via transmission channel 34. The encrypted data 20 may be transmitted in messages having a predetermined size. The messages may be sent cyclically, sporadically, or event-driven. If the amount of digital data 10 to be transmitted fluctuates, the code rate of the encrypted data 20 may be adjusted by the channel encoder 12 and/or the puncturer 26 such that the encrypted data 20 fills the payload area of a message completely or at least up to a certain lower limit. In other words, the payload area might be used as exhaustively as possible such that redundancy is increased (in what would otherwise be a smaller amount of to-be-transmitted data) to use the payload area as evenly and preferably as completely as possible.

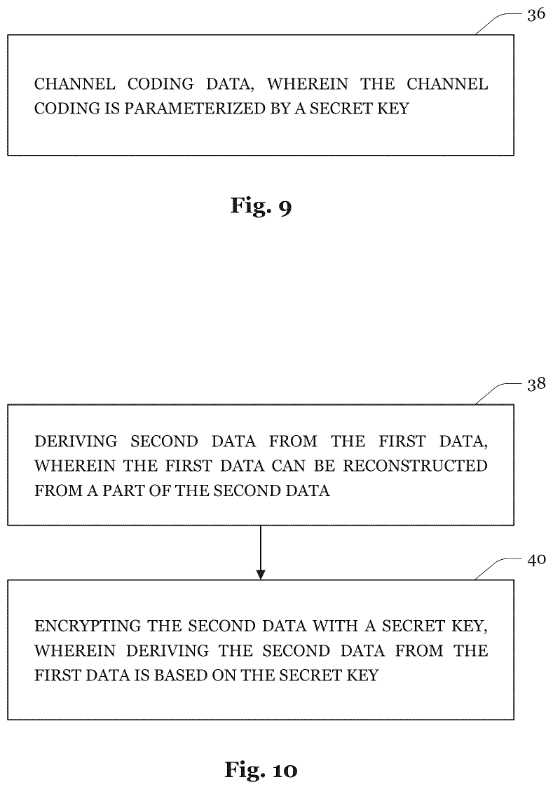

FIG. 9 shows a flowchart of a first method. The method comprises a step 36 of channel coding the digital data 10, wherein the channel coding is parameterized by the secret key 16.

FIG. 10 shows a flowchart of a second method. The method comprises a step 38 of deriving channel-coded data 14 from the digital data 10 and a step 40 of encrypting the channel-coded data 14 with the secret key 16, wherein the deriving of the channel-coded data 14 from the digital data 10 is based on the secret key 16.

The channel-coded data 14 or the encrypted channel-coded data 20 may be grouped into symbols and the symbols may be permuted. The permuting may be based on the secret key.

The derivation of the channel-coded data 14 from the digital data 10 on the basis of the secret key 16 may be carried out in a way such that the boundaries of the symbols 22 (and possibly the blocks 24) before and after the channel coding are not identical and may additionally vary over the runtime, as such concealment of the symbol boundaries and possibly the total length of the digital data 10 represents an additional hurdle for a decoding attempt without knowledge of the secret key 16. Irrespective of any possible prior independently performed source coding for compression, a shift in the symbol boundaries may be brought about by replacing the sequence of information symbols representing the digital data 10 with an equally long or longer sequence of code symbols representing the channel-coded data 14.

This may be achieved by systematically adding redundancy to the digital data 10 during channel coding, as this causes an increase in the number of symbols, wherein the extent of the increase depends on the selected coding method and its parameterization. Hence, whereas prior art methods for channel coding of digital data 10 may rely on uniform parameterization, the parameterization (e.g., the magnification factor) may be changed dynamically during coding as set out above, wherein the dynamics may be made dependent on the secret key 16. In this way, channel coding may contribute to cryptographic coding and serve as an additional layer of protection against unauthorized access to the digital data 10.

The dynamics may be applied in particular to:

The lengths of individual information segments.

The alphabet used to represent the information and/or code symbols within a segment.

The relative redundancy of the coded data within a segment.

The process (coding procedure) by which the redundancy is added.

If the dynamic change of the parameterization is derived from the secret key 16, a lack of knowledge with respect to the secret key 16 may result in the following:

An unknown segmentation of the digital data 10.

An unknown segmentation of the channel coded data 14.

An unknown assignment of segment boundaries between digital data 10 and channel-coded data 14.

An unknown mapping between individual information symbols and code symbols within associated segments.

The dynamics may be achieved, for example, by varying the block sizes in block codes or the code rate in convolutional codes (for example by varying puncturing).

Since channel coding adds systematic redundancy to the digital data 10, the coding process represents an injective function. The number of different code sequences that may be created by encoding a segment corresponds to the number of information sequences that the information segment can represent. This property is a prerequisite for error detection and/or error correction but may not be optimal in terms of information security. Since the code segment includes more symbols than the information segment, more assignments are possible. Ideal obfuscation might therefore make use of the entire value space of possible code segments. In addition, although the code symbols will also occur with equal probability if the information symbols occur with equal probability, due to the systematic nature of the coding, individual code symbols are related to each other. This property also contradicts ideal cryptographic coding.

It might therefore be advantageous to subject the sequence of code symbols generated during channel coding in its entirety to permutation and encryption. Cryptographic coding might therefore (in the order of encoding) advantageously be carried out after channel coding. The systematics between the individual information segments and the code segments may thus be spread across the entire data set. In addition, all symbols may then appear with the same probability in the coding output, even if this might not be the case in the input (provided that the key generation involves a sufficiently good random generator).

The coding methods described above may be used in a communication system which operates in time-division multiplexing with time windows of a constant size or several different but fixed sizes, wherein the number of transmittable code symbols per transmission has a fixed predetermined size. If the payload to be transmitted may change in size, the available space in a transmission may be fully utilized for systematic redundancy. This provides for individual options for parameterizing the encoding process.

Since each segment may thus contain a different relative amount of systematic redundancy, which may also cause the error detection and/or error correction quality to vary between segments, the minimum guaranteed systematic redundancy may be sufficiently dimensioned with a view to the largest possible amount of information to be sent in one transmission. This means that the relative redundancy adopted by the dynamics must not lead to the error detection and error correction quality to fall below

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A method for encoding first data, the method comprising:
channel coding the first data; and
parametizing the channel coding via a secret key.

2. The method for encoding first data of claim 1, wherein second data (14) are derived from the first data (10) by the channel coding, and wherein the method further comprises encrypting the second data (14) using the secret key (16).

3. A method for encoding first data, the method comprising:
deriving second data from first data, the first data being reconstructed from a part of the second data; and
encrypting the second data with a secret key,
wherein deriving the second data from the first data is based on the secret key.

4. The method for encoding first data of claim 3, wherein adding redundancy in deriving the second data from the first data is based on the secret key.

5. The method for encoding first data of claim 2, wherein deriving the second data from the first data is based on a block encoder which divides the first data into blocks, and wherein lengths of the blocks and/or an amount of redundancy added to a respective block and/or a process of adding redundancy to the blocks are based on the secret key.

6. The method for encoding first data of claim 2, wherein deriving the second data from the first data is based on a stream encoder, a parameterization of which changes after a certain amount of stream-coded data, and wherein a change in the parameterization is based on the secret key.

7. The method for encoding first data according to claim 6, further comprising:
puncturing the second data encoded by the stream encoder,
wherein the puncturing is based on the secret key.

8. The method for encoding first data of claim 2, further comprising:
grouping the second data or the encrypted second data into symbol; and
permuting the symbols, wherein the permuting is based on the secret key.

9. The method for encoding first data of claim 2, wherein one or more alphabets, by symbols of which the first data, the second data, and/or the encrypted second data are represented, are based on the secret key.

10. The method for encoding first data of claim 2, wherein deriving the second data from the first data and encrypting the second data on the basis of the secret key is carried out under a condition that the encrypted second data completely, or at least partially, fills a payload area of a message of predetermined size.

11. An encoder configured to carry out the method for encoding first data according to claim 1.

12. A decoder configured to detect and/or correct errors when decoding channel-coded data, wherein the decoding is based on a secret key with which the data is encrypted.
